(19) United States
(12) Patent Application Publication
(10) Pub. No.: US 2026/0319592 A1
(43) Pub. Date: Oct. 15, 2026

(54) VEHICULAR INTERFACE APPARATUS

(71) Applicant: DENSO CORPORATION, Kariya-city (JP)

(72) Inventors: Ryozo YAMASHITA, Kariya-city (JP); Yuta MATSUMOTO, Kariya-city (JP); Kiyokazu TAKAGI, Kariya-city (JP); Ryoma NIIHARA, Kariya-city (JP)

(21) Appl. No.: 19/687,776

(22) Filed: May 26, 2026

Related U.S. Application Data
(63) Continuation of application No. PCT/JP2024/040694, filed on Nov. 15, 2024.

(30) Foreign Application Priority Data
Nov. 27, 2023 (JP) 2023-200002

(51) Int. Cl. G06F 3/01; G07C 5/08

(52) U.S. Cl. CPC G06F 3/017; G07C 5/0825; G07C 5/0833

(57) ABSTRACT

In a vehicular interface apparatus to be installed in a vehicle for accepting a driver's input, a controller is configured to detect, using a contactless sensor mounted to the vehicle, leg state information including at least a motion of at least one foot of a driver, and analyze the leg state information to thereby identify at least one driver's input operation indicated by the leg state information.

### CROSS REFERENCE TO RELATED APPLICATION

This application is a bypass continuation application of currently pending international application No. PCT/JP2024/040694 filed on Nov. 15, 2024 designating the United States of America, the entire disclosure of which is incorporated herein by reference, the international application being based on and claiming the benefit of priority from Japanese Patent Application Publication No. 2023-200002 filed on Nov. 27, 2023, the disclosure of which is incorporated in its entirety herein by reference.

### TECHNICAL FIELD

The present disclosure relates to a vehicular interface apparatus installed in a vehicle for receiving input operations of a driver of the vehicle.

### BACKGROUND

Japanese Patent Publication No. 6126199 discloses a method and a system for performing control based on occupant's gestures in a vehicle. Specifically, the method and system for maintaining, based on predetermined gestures in combination with predetermined areas of the vehicle, correlations between the predetermined gestures and predetermined functions. One or more users in the vehicle can perform the predetermined gestures in predetermined areas of the vehicle. For example, such gestures include swiping, pointing, tapping, grabbing, and pinching. The predetermined areas include, for example, the steering wheel and air conditioning vents. The vehicle includes one or more cameras for recording three-dimensional images of user's gestures in the vehicle. The method and system detect a given gesture in a given area of the vehicle, the given gesture corresponding to one of the predetermined gestures and the given area corresponding to one of the predetermined areas. The method and system select a function associated with the given gesture associated with the given area based on the correlation between the function and the given gesture in the given area, and the method and system perform the selected function.

The functions may include various functions in the vehicle. For example, the functions may include: changing the volume or music selection of an audio system in the vehicle; changing the fan speed or temperature of an air conditioning system; changing the speed of windshield wipers in the vehicle; opening, closing, or changing the position of windows in the vehicle; opening, closing, or changing the position of a sun visor in the vehicle; opening, closing, or changing the position of a sunroof in the vehicle; and changing the speed of a cruise control system in the vehicle.

### SUMMARY

Conventional driving and vehicle operations are mainly performed via a steering wheel, pedals, and buttons. However, there remains room for improvement in convenience due to time lags before a driver's intentions are reflected in the vehicle's behavior, as well as the complicated arrangement of the buttons.

The technology disclosed in the patent publication is mainly based on driver's hand gestures. Regarding this point, a driver's foot, especially the driver's left foot with a lower possibility in acceleration/deceleration pedal operations, has a lot of freedom of movement, as compared with the driver's hands required to hold or be placed on the steering wheel.

In this regard, the driver's feet (particularly the driver's left foot, which is less likely to be used for acceleration or deceleration) offer greater freedom of movement compared to the hands, which are typically required to remain on or near the steering wheel. Accordingly, the driver's feet, particularly the driver's left foot, serves as an ideal means for reflecting the driver's intention.

The present disclosure has been made in view of the above-described circumstances. Specifically, the present disclosure provides a technology that enables, for example, more appropriately reflecting a driver's intention in driving control.

An aspect of the present disclosure provides a vehicular interface apparatus to be installed in a vehicle for accepting a driver's input. The vehicular interface apparatus includes a controller configured to detect, using a contactless sensor mounted to the vehicle, leg state information including at least a motion of at least one foot of a driver, and analyze the leg state information to thereby identify at least one driver's input operation indicated by the leg state information.

Note that each parenthesized reference character assigned to a corresponding element in the present disclosure merely represents an example of a relationship between the corresponding element and a corresponding specific element described in an present embodiment described later, and therefore the present disclosure is not limited to the parenthesized reference characters.

### BRIEF DESCRIPTION OF THE DRAWINGS

Other aspects of the present disclosure will become apparent from the following description of embodiments with reference to the accompanying drawings in which:

FIG. 1 is a schematic side view illustrating the interior of a vehicle equipped with a vehicular system;

FIG. 2 is an oblique perspective view illustrating a driver's footwell illustrated in FIG. 1;

FIG. 3 is a block diagram illustrating a schematic configuration of the vehicular system of a present embodiment;

FIG. 4 is a schematic view illustrating how a driver's foot moves detectable by a footwell condition sensor illustrated in FIG. 3; and

FIG. 5 is a schematic view illustrating how the driver's foot moves detectable by the footwell condition sensor illustrated in FIG. 3.

### DETAILED DESCRIPTION OF EMBODIMENTS

The following describes a present embodiment of the present disclosure with reference to the accompanying drawings. Note that descriptions of various modifications applicable to the present embodiment are collectively provided after the series of descriptions related to the present embodiment, as inserting them in the middle of the descriptions may hinder understanding of the present embodiment.

### Schematic Configuration of Vehicle

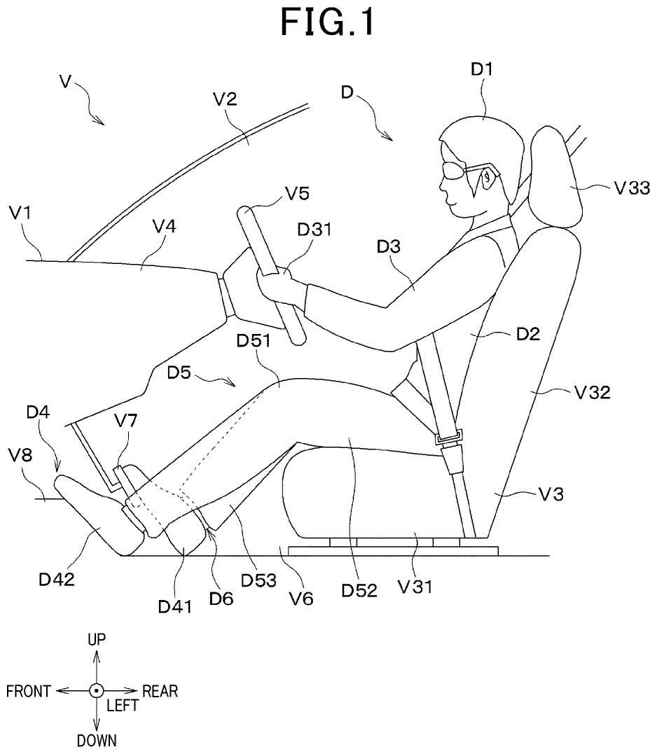

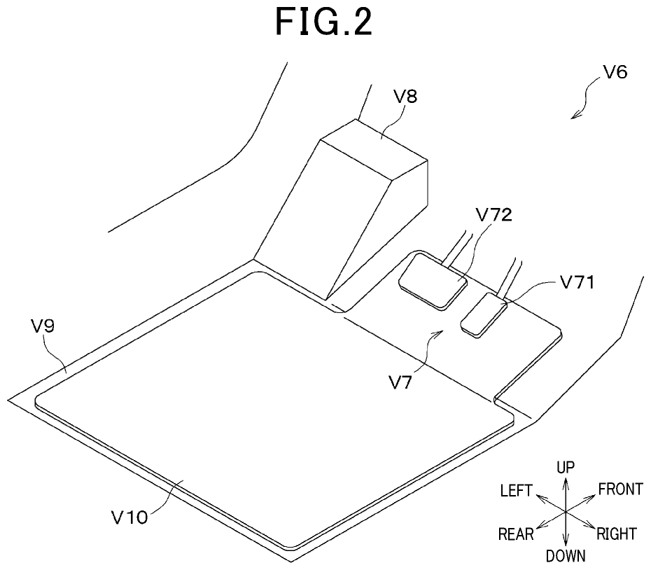

Referring to FIG. 1, a vehicle V according to the present embodiment is so-called passenger vehicle and has a body V1 having a substantially box shape. For simplification of description, directional concepts of “front”, “rear”, “up”, “down”, “right”, and “left” are defined as shown in FIGS. 1 and 2. “Down” is the same direction as the direction of gravitational action when the vehicle V is stably placed on a horizontal plane in a drivable state, and “up” is the opposite direction thereof. That is, a vertical direction, i.e., an up-down direction, is a direction parallel to the direction of gravitational action when the vehicle V is stably placed on a horizontal plane in a drivable state.

“Front” is a traveling direction when the vehicle V travels forward in a straight line on a horizontal plane, and “rear” is the opposite direction thereof. “Right” is the positive X-axis direction in a right-handed XYZ coordinate system where the positive Z-axis direction is “up” and the positive Y-axis direction is “front”, and “left” is the opposite direction thereof. That is, the left-right direction represents a direction parallel to the width direction of the vehicle V.

A plurality of occupant seats including a driver's seat V3 are provided in a vehicle interior V2, which is an internal space of the vehicle body V1. An occupant who occupies the driver's seat V3 is hereinafter referred to as a driver D. The driver's seat V3 includes a seat cushion V31 having a seating surface for the driver D, a seat back V32 that supports the driver D from behind, and a headrest V33.

A dashboard V4 is disposed in front of the driver's seat V3. A steering wheel V5 for steering the vehicle V is mounted to the dashboard V4 so as to project from the dashboard V4 toward the driver's seat V3.

Pedals V7 and a footrest V8 are provided in a footwell space V6, which is a space defined below the dashboard V4. As shown in FIG. 2, the pedals V7 include an accelerator pedal V71 and a brake pedal V72.

The accelerator pedal V71 and the brake pedal V72 are disposed such that the accelerator pedal V71 is located on the right side of the brake pedal V72. The footrest V8 is disposed on the left side of the brake pedal V72. That is, the accelerator pedal V71, the brake pedal V72, and the footrest V8 are arranged in this order from right to left. A floor V9 of the vehicle body V1 defines the bottom of the footwell space V6, and a floor mat V10 is laid on the floor V9.

FIG. 1 illustrates a state in which the driver D is seated in the driver's seat V3 in a driving posture. The “driving posture” refers to a proper seating posture of the driver D on the driver's seat V3, in which the driver D can accurately operate the steering wheel V5 and the pedals V7. In such a driving posture, the head D1 of the driver D is supported from behind by the headrest V33, and the torso D2 of the driver D is in close contact with the seat back V32. The arms D3 of the driver D extend forward while their elbows are slightly bent, and the hands D31 of the driver D grip the steering wheel V5. The feet D4 of the driver D are defined as parts of the legs D5 beyond their ankles D6. The right foot D41 of the feet D4 is positioned to operate the pedals V7, and the left foot D42 of the feet D4 is typically placed on the footrest V8.

That is, the vehicle V of the present embodiment is configured as a so-called automatic vehicle or semi-automatic vehicle that does not require a clutch operation by the left foot D42 of the driver D. The thighs D52 are defined as parts of the driver's legs D5 proximal to the knees D51 thereof. Most of the thighs D52 are in close contact with the seat cushion V31. The shins D53, which are parts between the feet D4 and the knees D51 of the legs D5, are positioned to extend diagonally forward and downward from the knees D51 so as to facilitate operation and switching of the pedals V7 with the right foot D41.

### Overall Configuration of Vehicular System

The vehicle V includes a vehicular system 1 installed therein. The vehicle V will also be referred to as a host vehicle V. The vehicular system 1, which is installed in the host vehicle V, is configured to serve as a driving automation system or an autonomous driving system in the system-installed vehicle V. The autonomous driving system is configured to implement, as a driving automation level, at least one of SAE levels (0 to 5 levels) defined in the SAE J3016 standard by SAE international; SAE is an abbreviation for “Society of Automotive Engineers”.

Level X in SAE J3016 is hereinafter simply referred to as “SAE level X”.

The “driving automation level” can be set to at least one of the SAE levels 0 to 5. The driving automation level may be higher as the SAE level X set as the driving automation level may be higher. An increase in the dynamic driving tasks to be performed by the autonomous driving system may result in an increase in the driving automation level. The driving automation level increases as the corresponding SAE level increases.

Similarly, the driving automation level may be lower as the SAE level X set as the driving automation level may be lower. A decrease in the dynamic driving tasks to be performed by the autonomous driving system may result in a decrease in the driving automation level. The driving automation level decreases as the corresponding SAE level decreases.

Accordingly, the driving automation level may increase or decrease due to an increase or decrease in the dynamic driving tasks to be performed by the autonomous driving system even while the driving automation level remains within the same SAE level (e.g., within SAE level 1 or 2).

### Definition of Driving Assistance and Autonomous Driving

SAE levels 0 to 5 will be specifically described below.

Hereinafter, the driver D is an occupant who manages and carries out the dynamic driving tasks. The dynamic driving tasks show all operational functions and all maneuver functions that need be carried out in real time by the driver D when the driver D drives the host vehicle V in traffic roads, except for strategical functions. Overall driving actions can be categorized into the operational functions, maneuver functions, and strategical functions.

The strategical functions may include functions of planning a travel schedule and selecting one or more places through the planned travel schedule. Specifically, the strategical functions may include functions of determining or selecting a travel schedule that shows (i) whether to go to a destination, (ii) when to go to the destination, and (iii) how to go to the destination.

The maneuver functions may include functions of determining, in various traffic situations, various maneuvers that may include, during the scheduled travel, (i) determining whether and when to overtake, (ii) determining whether and when to make a lane change, and (iii) checking the mirrors.

The operational functions may include driver's instantaneous reactions, such as steering operations, braking operations, accelerating operations, and/or minor adjustments of these operations, in order to keep a position of the host vehicle V in a corresponding lane of a road and/or avoid at least one obstacle and/or at least one dangerous event on the path of the moving host vehicle V.

OEDR is an abbreviation for “Object and Event Detection and Response”, and can be called “detection and response of objects and events”. OEDR includes the monitoring of driving environment around the host vehicle V. The monitoring of the driving environment around the host vehicle V may include detection, recognition, and classification of one or more objects and/or events. The monitoring of the driving environment around the host vehicle V may additionally include preparation of response for the one or more objects and/or events. Operational Design Domain (ODD) conditions, which will also be called “specific domain conditions”, represent specific conditions under which a given autonomous driving system or feature thereof is designed to function. The ODD conditions may include, for example, at least one of a plurality of limiting conditions including, for example, geographic conditions, environmental conditions, velocity conditions, and time conditions.
SAE level 0 represents No Autonomous driving, which represents that the driver D performs all the dynamic driving tasks.
SAE level 1 represents Driving Assistance, which represents that an autonomous driving system sustainably executes, under specific ODD conditions, either the lateral vehicle motion control subtasks or the longitudinal vehicle motion control subtasks of the dynamic driving tasks. The longitudinal vehicle motion control subtasks include, for example, forward/backward operation, acceleration/deceleration operation, and stop operation. The lateral vehicle motion control tasks include, for example, steering operation. In particular, the autonomous driving system is configured not to perform simultaneously both the lateral vehicle motion control subtasks and the longitudinal vehicle motion control subtasks.
SAE level 2 represents Advanced Driving assistance, which represents that an autonomous driving system sustainably executes, under specific ODD conditions, both the lateral vehicle motion control subtasks and the longitudinal vehicle motion control subtasks of the dynamic driving tasks with expectation that the driver D completes OEDR subtasks and supervises the autonomous driving system.
SAE level 3 represents Conditional Autonomous driving, which represents that a driving automatic system sustainably executes, under specific ODD conditions, all the dynamic driving tasks. Under the specific ODD conditions, the driver D is not required to perform one of the OEDR subtasks of monitoring the traffic environment around the host vehicle V, but, when the driving automatic system has a difficulty continuing at SAE level 3, the driving automatic system requests the driver D to control the host vehicle V with plenty of time, so that the driver D needs to smoothly respond to the request.
SAE level 4 represents High Automation, which represents that a driving automatic system sustainably executes, under specific ODD conditions, all the dynamic driving tasks. When the driving automatic system has a difficulty continuing at SAE level 4, the driving automatic system addresses the difficulty.
SAE level 5 represents Full Automation, which represents that a driving automatic system on the host vehicle V sustainably executes all the dynamic driving tasks without limitation in all the ODD conditions. When the driving automatic system has a difficulty continuing at SAE level 5, the driving automatic system addresses the difficulty without limitation in all the ODD conditions.

The vehicular system 1 is configured to be able to execute various types of driving control during driving of the host vehicle V and various types of notification or warning operations accompanying the driving control. Specifically, the vehicular system 1 is configured to be able to execute autonomous driving of the SAE level 3 or 4, advanced driving assistance (support) of the SAE level 2, and driving assistance of the SAE level 1. For this reason, the vehicular system 1 of the present embodiment may also be referred to as an autonomous driving system during execution of the autonomous driving and to a driving assistance system during execution of driving assistance or advanced driving assistance.

The advanced driving assistance that can be carried out by the vehicular system 1 of the present embodiment may include hands-off driving. The hands-off driving enables the vehicular system 1 to automatically move the host vehicle V forward or backward, steer the host vehicle V, accelerate or decelerate the host vehicle V, make lane changes of the host vehicle V, and/or stop the host vehicle V as long as the driver D addresses appropriately any intervening requests and other requests issued from the vehicular system 1.

Hands-off driving requests the driver D to monitor road conditions around the host vehicle V, traffic situations around the host vehicle V, and information about whether there are one or more obstacles around the host vehicle V without requesting the driver D to be in a hands-on state. The hands-on state represents a state of the driver D in which the driver D is ready to steer the host vehicle V, i.e., ready to intervene in the lateral vehicle motion control subtasks. The hands-on state typically represents a state of the driver D in which the driver D is sitting in the driver's seat V3 with the driving posture and is ready to properly operate the steering wheel V5 and the pedals V7. The driver D being in the hands-on state generally grasps the steering wheel V5 with the hands D31. The hands-on state also applies to the state in which the driver D touches the steering wheel V5 with the hands D31 while being ready to grasp the steering wheel V5.

During autonomous driving, a leg-on state is not required and a leg-off state is permitted. Similarly, depending on the content of advanced driving assistance being executed, the leg-on state is not required and the leg-off state is permitted.

The “leg-on state” refers to a state in which one of the feet D4 of the driver D in the driving posture is placed at a position where any one of the pedals V7 can be immediately depressed, and typically refers to a state in which the right foot D41 is placed on any one of the pedals V7. The “leg-on state” includes a state in which one of the feet D4 of the driver D is depressing any one of the pedals V7 and a state in which one of the feet D4 is not depressing but is lightly touching any one of the pedals V7.

In contrast, the “leg-off state” refers to a state in which one of the feet D4 of the driver D is not placed at a position where any pedal V7 can be immediately depressed, and typically refers to a state in which the right foot D41 is not placed on any pedal V7. Specifically, for example, during the execution of ACC (which is an abbreviation for Adaptive Cruise Control), during hands-off driving, or during autonomous driving, the leg-off state is permitted. That is, during the execution of ACC, during hands-off driving, or during autonomous driving, the driver D can place the right foot D41 in front of or to the right of the accelerator pedal V71, or raise the right foot D41 upward using an ottoman (not shown).

ACC is configured to perform (i) cruise control for causing the host vehicle V to travel for maintaining a constant target speed when no preceding vehicle exists in front of the host vehicle V, and (ii) following control for causing, when a preceding vehicle is present in front of the host vehicle V, the host vehicle V to travel while following the preceding vehicle at controlled speeds that are equal to or lower than the target speed.

Thus, the vehicular system 1 according to the present embodiment may also be simply referred to as an autonomous driving system during execution of the autonomous driving of the SAE level 3 unless mentioned otherwise.

### Configuration of Vehicular System

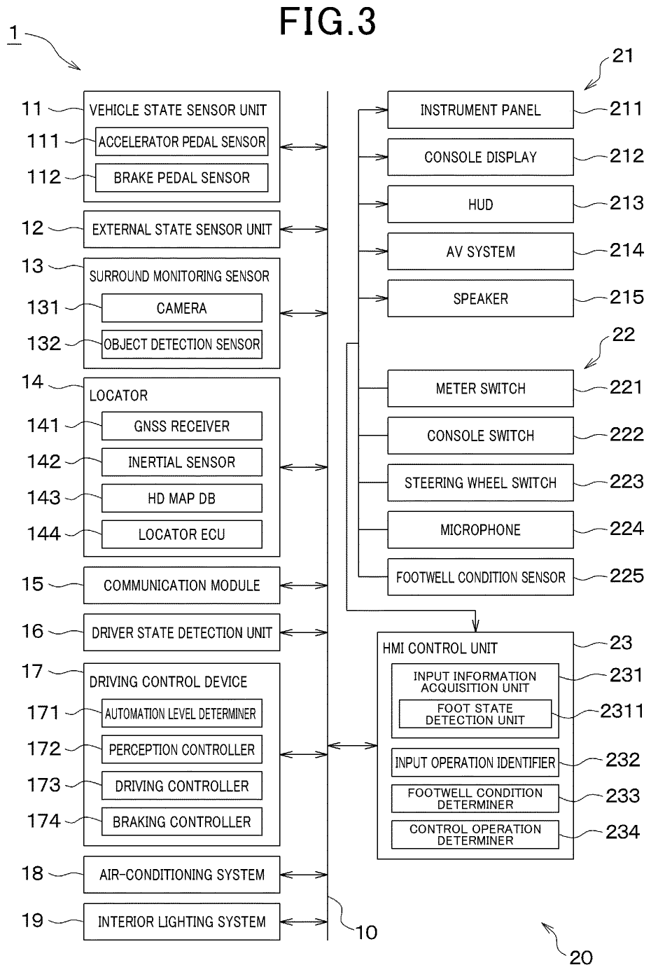

As illustrated in FIG. 3, the vehicular system 1 has a configuration as an in-vehicle network including an in-vehicle communication network 10 and a plurality of nodes and the like connected to each other via the in-vehicle communication network 10. The in-vehicle system 1 is configured to comply with a predetermined communication standard such as CAN®. CAN® is an abbreviation for Controller Area Network.

The vehicular system 1 includes a vehicle state sensor unit 11, an external state sensor unit 12, a surround monitoring sensor unit 13, a locator 14, a communication module 15, a driver state detection unit 16, a driving control device 17, an air-conditioning system 18, an interior lighting system 19, and an HMI apparatus 20. HMI is an abbreviation for Human Machine Interface.

The HMI apparatus 20 includes an output unit 21, an input unit 22, and an HMI control unit 23, i.e., HCU 23. The components from the vehicle state sensor unit 11 to the interior lighting system 19 and the HMI control unit 23 are connected to the in-vehicle communication network 10. The output unit 21 and the input unit 22 are connected to the HMI control unit 23.

### Various Sensors

The vehicle state sensor unit 11 is configured to generate an output signal corresponding to each of various driving-state parameters of the host vehicle V. The “various driving-state parameters” include, for example, driving-operational state parameters by the driver D or the autonomous driving system, such as an opening degree of the accelerator, the operation quantity of the brake, the position of the shift lever, and an operation angle of the steering. Additionally, the “various driving-state parameters” include, for example, physical parameters related to the behavior of the host vehicle V, such as the speed of the host vehicle V, the angular velocity of the host vehicle V, the longitudinal acceleration of the host vehicle V, and the lateral acceleration of the host vehicle V.

Specifically, the vehicle state sensor unit 11 include well-known sensors that are necessary for vehicle driving control, such as a steering angle sensor, a speed sensor for each wheel, an angular velocity sensor, and longitudinal and lateral acceleration sensors in addition to an accelerator pedal sensor 111 and a brake pedal sensor 112. The vehicle state sensor unit 11 is configured to provide, via the in-vehicle communication network 10, generated output signals of the various driving-state parameters to each of predetermined components of the host vehicle V, such as the driving control device 17.

The external state sensor unit 12 is configured to generate an output signal corresponding to various natural-environmental parameters included in driving-environment parameters surrounding the host vehicle V. The “various natural-environmental parameters” include, for example, physical parameters such as an outside temperature, an amount of rainfall, and illuminance.

Specifically, the external state sensor unit 12 is a generic term, which includes well-known sensors such as an outside temperature sensor, a raindrop sensor, and an illuminance sensor for simplification of illustration and description. The external state sensor unit 12 is configured to provide, via the in-vehicle communication network 10, generated output signals of the various natural-environmental parameters to each of the predetermined components of the host vehicle V, such as the driving control device 17.

The surround monitoring sensor unit 13 is configured to detect surrounding parameters included in the driving-environment parameters other than the natural-environmental parameters detectable by the external state sensor unit 12. Specifically, the surround monitoring sensor unit 13 is configured to be capable of detecting moving objects and stationary objects in a predetermined detection region around the host vehicle V.

“Moving objects” include pedestrians, cyclists, animals, and other traveling vehicles. “Stationary objects” include fallen objects on a road, guardrails, curbs, parked vehicles, road signs, road markings, and roadside structures (e.g., walls, buildings, etc.). The surround monitoring sensor unit 13 may also be referred to as an “ADAS sensor unit”.

The surround monitoring sensor unit 13 of the present embodiment includes one or more cameras 131 and one or more object detection sensors 132 as components for monitoring and detecting moving objects and stationary objects.

The one or more cameras 131 are arranged to capture images around the host vehicle V. Each camera 131 of the present embodiment is a digital camera device and includes an image sensor such as a CCD or a CMOS image sensor. CCD is an abbreviation for Charge Coupled Device. CMOS is an abbreviation for Complementary Metal-Oxide-Semiconductor.

Each object detection sensor 132 is a millimeter-wave radar sensor, a submillimeter-wave radar sensor, or a laser radar sensor that transmits and receives radar waves, and is mounted to a corresponding front portion of the vehicle body V1 in the host vehicle V. Each object detection sensor 132 is configured to output a signal corresponding to the position and relative speed of each reflection point. The “reflection point” is a point on the surface of an object existing around the host vehicle V, at which transmitted radar waves from an object detection sensor 132 are estimated to have been reflected to produce reflected waves (echoes). The “relative speed of a reflection point” is a speed of the reflection point relative to the host vehicle V; that is, a relative speed of an object corresponding to the reflection point with respect to the host vehicle V.

### Locator

The locator 14 is configured to acquire, for example, highly accurate position information about the host vehicle V using so-called complex positioning. Specifically, the locator 14 is comprised of a GNSS receiver 141, an inertial sensor 142, a high-definition (HD) map database (DB) 143, and a locator ECU 144.

The GNSS is an abbreviation for Global Navigation Satellite System, and the highly accurate position information about the host vehicle V is positional information on the host vehicle V, which has at least a position accuracy usable by the advanced driving assistance in the SAE level 2 or more, in other words, a position accuracy with an error of lower than or equal to 10 cm.

The GNSS receiver 141 is configured to receive navigation signals transmitted from a plurality of positioning satellites, that is, a plurality of artificial satellites. In particular, the GNSS receiver 141 is configured to be capable of receiving the navigation signals from a positioning satellite included in at least one GNSS selected from the GPS, the QZSS, the GLONASS, the GLONASS, the Galileo, the IRNSS, and the Beidou Navigation Satellite System. GPS is an abbreviation for Global Positioning System, QZSS is an abbreviation for Quasi-Zenith Satellite System, GLONASS is an abbreviation for Global Navigation Satellite System, and IRNSS is an abbreviation for Indian Regional Navigation Satellite System.

The inertial sensor 142 is configured to detect (i) three-axes accelerations acting on the host vehicle V and (ii) angular velocities acting on the host vehicle V around the respective three axes. For example, the locator 14 has a substantially box-shaped housing, and the inertial sensor 142 is comprised of a three-axis accelerometer and a three-axis gyro sensor installed in the housing.

The HD map DB 143 is comprised of mainly one or more non-volatile rewritable memories, and is configured to store HD map information to be rewritable while holding the stored HD map information even if power supplied to the HD map database 143 is shut off. The non-volatile rewritable memories include, for example, a hard disk drive, an Electronically Erasable and Programmable Read Only Memory (EEPROM), and a flash ROM.

The HD map information, which will also be referred to as HD map data, includes higher-definition map information having a positional error lower than or equal to an error of approximately several meters of the map information stored in the navigation system 18.

Specifically, the HD map information DB 143 for example stores, as the HD map information, map information available by autonomous driving of the SAE level 2 or more, which includes, for example, (i) information about three-dimensional road shapes, (ii) information about the number of lanes in each road, and (iii) information about road traffic regulations. The HD map information is stored in the HD map information DB 143 to be in conformity with a predetermined standard, such as ADASIS.

The locator ECU 144 includes a vehicular microcomputer comprised of a Central Processing Unit (CPU), a ROM, a Random Access Memory (RAM), an input/output (I/O) interface, and other peripheral devices. The locator ECU 144 is configured to sequentially calculate the current position and/or the current azimuth of the host vehicle V in accordance with (i) the navigation signals received by the GNSS receiver 141, (ii) the accelerations and angular velocities detected by the inertial sensor 142, and (iii) the speed of the host vehicle V acquired from the vehicle state sensor unit 11. The locator 14 is configured to provide, to each of the predetermined components of the host vehicle V, such as the driving control device 17 and/or the HMI control unit 23, the calculation results, i.e., the current position and/or the current azimuth of the host vehicle V sequentially calculated by the locator ECU 144.

### Communication Module

The communication module 15, which will also be referred to as a Data Communication Module (DCM) 15, can be configured to establish vehicle-to-everything (V2X) communication for the host vehicle V via wireless connectivity compliant with a predetermined standard.

Specifically, the communication module 15 is configured to retrieve, from probe servers in a cloud computing environment, latest HD map information, and cooperate with the locator ECU 144 to accordingly store the latest HD map information in the HD map database 143.

Additionally, the communication module 15 is configured to acquire traffic information related to traffic situations, such as traffic-jam information, from the probe servers and/or predetermined databases. Moreover, the communication module 15 is configured to acquire, from the probe servers and/or the predetermined databases, information including a lighting state of one or more traffic lights installed at respective intersections ahead of the host vehicle V, a timing of a change in the lighting state, and other information.

### Driver State Detection Unit

The driver state detection unit 16 is configured to detect a driver state. The “driver state” is a state of the driver D of the host vehicle V, and includes at least any one of a line-of-sight direction, a posture, a behavior, a psychological state, and the other similar information. Specifically, the driver state detection unit 16 of the predetermined embodiment detects, for example, the orientation of the face of the driver D, the line-of-sight direction of the driver D, the seating posture of the driver D, the gripping state of the steering wheel V5 of the driver D. The driver state detection unit 16 is configured to provide, via the n-vehicle communication network 10, the detected driver state to each of the predetermined components of the host vehicle V, such as the driving control device 17 and/or the HMI control unit 23.

### Driving Control Device

The driving control device 17 is configured to control driving of the host vehicle V, such as acceleration/deceleration and steering of the host vehicle V, based on the signals and/or information acquired from, for example, the vehicle state sensor unit 11, the external state sensor unit 12, the surround monitoring sensor unit 13, and the locator 14. The driving control device 17 of the present embodiment is configured as an autonomous driving ECU or a driving assistance ECU. That is, the driving control device 17 is configured to execute predetermined driving control operations to implement an autonomous driving function and a driving assistance function. The predetermined driving control operations include all driving control operations, i.e., all dynamic driving tasks, corresponding to the SAE levels 1 to 4.

The driving control device 17 is configured as a vehicular microcomputer that includes a CPU, a ROM, a nonvolatile rewritable memory, a RAM, an I/O interface, and other peripheral devices. Specifically, the driving control device 17 includes, as functional components or functional units implemented on the vehicular microcomputer, an automation level determiner 171, a perception controller 172, a driving controller 173, and a braking controller 174.

The automation level determiner 171 of the present embodiment sets the driving automation level in the host vehicle V to any one of the SAE levels 0 to 3. In addition, the automation level determiner 171 switches activation and deactivation of the driving assistance function. That is, the automation level determiner 171 is configured to determine a driving mode; that is, the automation level determiner 171 determines whether to operate in a manual driving mode or an autonomous driving mode related to the autonomous driving in accordance with the driving automation level.

The automation level determiner 171 is configured to provide, via the in-vehicle communication network 10, information indicating the determined driving mode to each of the predetermined components of the host vehicle V, such as the HMI control unit 23.

The perception controller 172 is configured to control the surround monitoring sensor unit 13, so that the surround monitoring sensor unit 13 monitors and detects one or more objects around the host vehicle V under control of the perception controller 172. The perception controller 172 is additionally configured to recognize, based on the detected one or more objects around the host vehicle V, the one or more objects.

The driving controller 173 is configured to control operations of a drive system, i.e., a powertrain, installed in the host vehicle V. That is, the driving controller 173 is configured to control operations of one or more drive sources, such as an engine and/or a motor included in the powertrain, and control operations of a power transmission mechanism (e.g., a transmission mechanism, etc.), which is included in the powertrain and arranged between the one or more driving sources and the wheels of the host vehicle V.

The braking controller 174 is configured to control operations of a braking mechanism installed in the host vehicle V. That is, the braking controller 174 is configured to execute, for example, control of a braking pressure, which is a pressure of a working fluid in a friction brake mechanism included in the braking mechanism and control of a braking force to be applied to each wheel of the host vehicle V. Additionally, the braking controller 174 is configured to control the operating state, i.e., on/off and the braking force, of a regenerative braking system installed in the host vehicle V.

### Air-Conditioning System

The air-conditioning system 18 is configured to adjust the temperature in the vehicle interior V2. Specifically, the air-conditioning system 18 is configured to have a heating function to increase the temperature in the vehicle interior V2 and a cooling function to supply cooling air into the vehicle interior V2.

### Interior Lighting System

The interior lighting system 19 is configured to be capable to variably setting the lighting state in the vehicle interior V2. Specifically, the interior lighting system 19 includes ambient lights mounted to, for example, the ceiling and/or the door trims in the vehicle interior V2, and the interior lighting system 19 is configured such that each ambient light is controlled to change its lighting state including emitted light with variable colors. Specifically, the interior lighting system 19 serves as a vehicle-interior system that provides visual information to the driver of the host vehicle V.

### HMI System

The HMI apparatus 20 is configured to accept input operations from one or more occupants, such as the driver D, other than accelerator operations and brake operations by the pedals V7, and visually and audibly output various types of information and/or contents toward the one or more occupants. Specifically, the output unit 21 includes an instrument panel 211, a console display 212, a HUD 213, an AV system 214, and a speaker 215. HUD is an abbreviation for Head-Up Display. Additionally, the input device 22 includes meter switches 221, console switches 222, steering wheel switches 223, a microphone 224, and a footwell condition sensor 225.

The instrument panel 211 is mounted to the dashboard V4 and includes a meter display that displays the traveling state parameters of the host vehicle V, such as the speed and the coolant temperature of the host vehicle V, and an information display that displays various types of information, such as radio reception stations and the mileage of the host vehicle V.

The console display 212 is mounted to a center console (not shown) of the host vehicle V, and is configured to display the navigation images generated by the navigation system 18, contents for secondary tasks (secondary task contents), and other types of information. The secondary tasks refers to non-driving tasks performed by the driver D, such as reading, operating a mobile communication terminal, viewing video contents. “Video contents” are, for example, movies, concert videos, music videos, television broadcasts, and the like. The secondary tasks are also referred to as “secondary activities”.

The HUD 213 is configured to display a virtual image including letters, figures, and/or characters in the driver's forward view. The HUD 213 is configured to project the virtual image in front of the driver D using AR technologies to accordingly superimpose the virtual image on the forward scenery including a road surface located on a traveling course of the host vehicle V; AR is abbreviated for Augmented Reality.

The AV system 214 is configured to cause the console display 212 and the speaker 215 to output music contents and/or video contents. The speaker 215 is configured to audibly output the contents supplied from the AV system 214, and audibly output various types of guidance, notification, or warning during driving of the host vehicle V.

Accordingly, the output unit 21 serves as a vehicular device designed to provide visual and/or auditory feedback to the driver D.

The meter switches 221 are configured to accept occupant's various operations related to the information items and/or contents displayed on the instrument panel 211, such as an operation of resetting a trip meter included in the instrument panel 211.

The console switches 222 are disposed around the console display 212 and are configured to accept occupant's operations related to, for example, the air-conditioning system 18 and the AV system 214.

The steering wheel switches 223 are mounted to the spokes or other portions of the steering wheel V5. The steering wheel switches 223 are configured to accept various operations, such as changing information items displayed on the instrument panel 211 and/or adjusting the volume of the AV system 214.

The microphone 224 is configured to receive audio input from the driver's speech.

The footwell condition sensor 225 is a contactless sensor for detecting a foot state of at least one of the feet D4 of the driver D, in a non-contact manner and is provided in an upper portion of the footwell space V6. The foot state of at least one of the feet D4 of the driver D includes the position and motion or movement of the at least one of the feet D4 of the driver D, and the combination of the position and motion or movement thereof. Specifically, the footwell condition sensor 225 is configured to output an image signal including sensor information related to the foot state of the at least one of the feet D4 of the driver D. The footwell condition sensor 225 of the present embodiment is a so-called footwell camera that captures an image of the footwell space V6 from above, and is arranged to have a field of view that includes at least the pedals V7 and its surroundings.

Specifically, the footwell condition sensor 225 is configured to detect, for example, whether one of the feet D4 is mounted on the accelerator pedal V71 or on the brake pedal V72 or one of the feet D4 is moving one of the accelerator pedal V71 and the brake pedal V72 to the other thereof.

Additionally, the footwell condition sensor 225 is configured to detect states of the feet D4 and the legs D5 of the driver D and surrounding conditions in the footwell space V6. The “states” of the feet D4 and the legs D5 include footwear types, motions, orientations, and bending states of joints. That is, the states of the legs D5 include positions, orientations, motions, and combinations thereof of the knees D51, thighs D52, and shins D53. The “surrounding conditions” include a motion hindrance condition that hinders motion of the feet D4. The motion hindrance condition includes the presence of obstacles in the footwell space V6, anomalies of the floor mat V10, and/or the presence of deposits on each pedal V7. The anomalies of the floor mat V10 include misalignment, curling, and/or non-conformance (i.e., inappropriate shape or size relative to the floor V9).

### HMI Control Unit

The HMI control unit (HCU) 23, which controls operations of the output unit 21 and the input unit 22 included in the HMI apparatus 20, is configured as a vehicular microcomputer that includes a CPU, a ROM, a nonvolatile rewritable memory, a RAM, an I/O interface, and other peripheral devices (not shown). The HMI control unit 23 includes, as functional components or functional units implemented on the vehicular microcomputer, an input information acquisition unit 231, an input operation identifier 232, a footwell condition determiner 233, and a control operation determiner 234.

The input information acquisition unit 231 is configured to acquire input information from the input unit 22.

In particular, the input information acquisition unit 231 of the present embodiment includes a foot state detection unit 2311. The foot state detection unit 2311 is configured to detect the states of the feet D4 based on the image signal acquired from the footwell condition sensor 225. The states of the feet D4 include, for example, the positions of the feet D4, the motions of the feet D4, and/or the gestures of the feet D4.

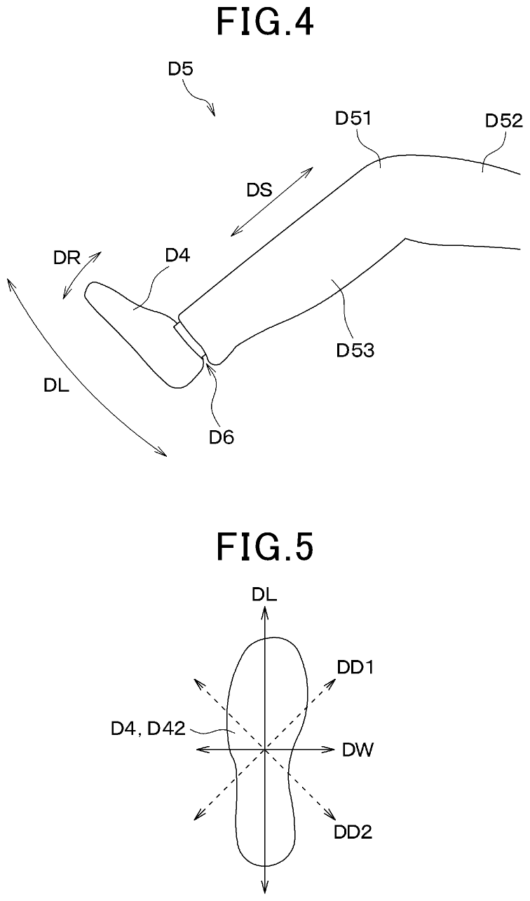

FIGS. 4 and 5 schematically show directions of motions of each foot D4; the motions of each foot D4 constitute gestures of the corresponding foot D4. As shown in FIG. 4, each foot D4 can move in a depressing direction DS along a direction in which the shin D53 extends by expansion and contraction of the leg D5. Additionally, each foot D4 can move in a dorsiflexion-plantarflexion direction DR representing the direction of dorsiflexion and plantarflexion along a rotational path centered on the ankle D6. That is, each foot D4 can rotate in the dorsiflexion direction in which the toes at the distal end of the corresponding foot D4 approach the knee D51, and in the plantarflexion direction in which the toes move away from the knee D51.

Furthermore, each foot D4 can move along a foot length direction DL as a first direction by rotation of the shin D53 along the longitudinal direction centered on the knee D51. The foot length direction DL is a direction that defines the length size of each foot D4 along the direction from the heel toward the toes, and is orthogonal to a foot width direction DW, which will be described later.

The foot length direction DL is a direction along the longitudinal direction in a plan view from vertically above, and specifically intersects the longitudinal direction so as to be parallel or form a small angle of about 20 degrees or less with respect to the longitudinal direction.

Each foot D4 can move in the foot width direction DW as a second direction. The foot width direction DW is a width direction of each foot D4, and intersects the lateral direction so as to be parallel or form a small angle of about 20 degrees or less with respect to the lateral direction in a plan view from vertically above. That is, the foot width direction DW is a direction along the lateral direction.

The depressing direction DS as a third direction is defined as a direction intersecting both the foot length direction DL and the foot width direction DW, typically defined as a direction orthogonal to both the foot length direction DL and the foot width direction DW.

As shown in FIG. 5 in which each foot D4 is viewed from above or obliquely from above with a line of sight along the depressing direction DS, each foot D4 can move in a first inclined direction DD1 and a second inclined direction DD2 that intersect the foot length direction DL and the foot width direction DW. As shown in FIG. 5, let us assume that a coordinate system is defined wherein the horizontal and vertical axes correspond to the foot width direction DW and the foot length direction DL, respectively. In this assumption, the first inclined direction DD1 is a direction from the origin of the coordinate system toward the first quadrant or the third quadrant, and the second inclined direction DD2 is a direction from the origin toward the second quadrant or the fourth quadrant.

As described above, the motions and gestures of the feet D4 are three-dimensional motions and gestures thereof. The directions of the motions and gestures of the feet D4 include at least one of the foot length direction DL, the foot width direction DW, the depressing direction DS, the dorsiflexion-plantarflexion direction DR, the first inclined direction DD1, and the second inclined direction DD2. In other words, the directions of the motions and gestures of the feet D4 include at least one of the longitudinal direction, the lateral direction, and the vertical direction.

The input operation identifier 232 is configured to identify one or more input operations by the feet D4 of the driver D based on the recognized states of the feet D4 of the driver D acquired from the foot state detection unit 2311.

The footwell condition determiner 233 is configured to identify the surrounding conditions around the feet D4 of the driver D in the footwell space V6 based the image signal acquired from the footwell condition sensor 225. More specifically, the footwell condition determiner 233 is configured to determine, based on the identified surrounding condition, whether at least one motion hindrance condition that hinders motion of the feet D4 has occurred in the footwell space V6.

The control operation determiner 234 is configured to determine control operations for the host vehicle V in accordance with (i) the details of the one or more input operation by the feet D4 of the driver D and (ii) the determination result of the footwell condition identifier 233.

Specifically, the control operation determiner 234 is configured to determine operation details, i.e., control operations, for each of selected components included in the host vehicle V in accordance with the details of the one or more input operation by the feet D4 of the driver D. Additionally, the control operation determiner 234 is configured to issue a warning to the driver D using the output unit 21 when the determination result represents that at least one motion hindrance condition that hinders motion of the feet D4 has occurred in the footwell space V6.

### Operation Overview

The following describes an overview representing how the vehicular system 1 configured set forth above operates according to the present embodiment, and advantageous benefits achieved by the vehicular system 1 with reference to the accompanying drawings.

The driving control device 17 of the vehicular system 1 controls driving of the host vehicle V based on the signals and/or information acquired from, for example, the vehicle state sensor unit 11, the external state sensor unit 12, the surround monitoring sensor unit 13, the locator 14, the driver state detection unit 16, and the HMI control unit 23.

Specifically, the driving control device 17 serves as the driving controller 173 to control operations of the one or more drive sources and operations of the power transmission mechanism in accordance with, for example, the acquired driving-state parameters of the host vehicle V from the vehicle state sensor unit 11, such as the accelerator pedal sensor 111. Additionally, the driving control device 17 serves as the braking controller 174 to control operations of the braking mechanism in accordance with, for example, the acquired driving-state parameters of the host vehicle V from the vehicle state sensor unit 11, such as the brake pedal sensor 112.

The driving control device 17 additionally controls the operation of each of the air-conditioning system 18, the interior lighting system 19, and the AV system 214 in accordance with, for example, the signals and/or information acquired from, for example, the input device 22.

Additionally, the driving control device 17 selects one of the SAE levels based on, for example, the current position and speed of the host vehicle V and the driver state, and determines the selected one of the SAE levels as the driving automation level, thereby operating the host vehicle V in the determined driving automation level. For example, if the vehicular system 1 is activated without a driver's input and an initial setting, the driving control device 17 sets the driving automation level to the SAE level 1, in which the driving control device 17 is capable of executing emergency automated braking and collision mitigation control. The “initial setting” here includes the setting of the driving automation level and/or the driving mode saved at the last deactivation of the vehicular system 1, which can be used for the next activation of the vehicular system 1.

Accordingly, when the initial setting for example indicates that the autonomous driving with the SAE level 3 or more was being executed immediately before the last deactivation of the vehicular system 1, the driving control device 17 is capable of setting the driving automation level to the SAE level 3 corresponding to the autonomous driving mode at the current activation of the vehicular system 1. As another example, when (i) the host vehicle V, which has not satisfied the ODD conditions for the SAE level 3, satisfies all the ODD conditions for the SAE level 3 and (ii) transition approval to the SAE level 3 is inputted from the driver D, the driving control device 17 transitions the driving automation level from the current SAE level (which is 2 or lower) to the SAE level 3.

As described above, the host vehicle V of the present embodiment is configured as a so-called automatic vehicle or semi-automatic vehicle that does not require a clutch operation by the left foot D42 of the driver D. For this reason, the driver D can move, without interfering with driving, the left foot D42 more freely than the right foot D41 can move the left foot D42 more freely than the right foot D41 within a range that does not interfere with driving. Additionally, during ACC or autonomous driving, the driver D can also move the right foot D41 relatively freely, except for situations where an override operation is required by depressing a pedal V7.

In contrast, the driver D is required to grasp the steering wheel V5 or touch it while being ready to grasp the steering wheel V5 during the driving automation level being set to the SAE level 2 or lower. Therefore, the feet D4 of the driver D, particularly, the left foot D42, which is less likely to operate any pedal V7 for acceleration or deceleration, are suitable for performing input operations to express the driver's intention.

From this viewpoint, the foot state detection unit 2311 of the present embodiment is configured to acquire, using the contactless footwell condition sensor 225, leg state information indicative of the state of at least one foot D4 of the driver D; the state of the at least one foot D4 of the driver D includes at least the motion of the at least one foot D4. Then, the foot state detection unit 2311 is configured to recognize the state of the at least one foot D4 of the driver D.

Specifically, the foot state detection unit 2311 is configured to recognize one or more gestures of at least one foot D4 of the driver D based on the signal acquired from the footwell condition sensor 225; the gestures of the at least one foot D4 include at least one of (i) a motion of the at least one foot D4 in the longitudinal direction along the foot length direction DL and (ii) a motion of the at least one foot D4 in the left-right direction along the foot width direction DW.

Typically, the foot state detection unit 2311 is configured to recognize motions and/or their motional gestures of the left foot D42 of the driver D. In particular, the foot state detection unit 2311 is configured to recognize, in ACC driving mode or autonomous driving mode, motions and/or their motional gestures of the right foot D41 of the driver D.

More specifically, the foot state detection unit 2311 is configured to recognize, for example, motions of at least one foot D4 of the driver D in the depressing direction DS and/or the dorsiflexion-plantarflexion direction DR (see FIG. 4). As another example, the foot state detection unit 2311 is configured to recognize motions of at least one foot D4 of the driver D in the foot length direction DL, the foot width direction DW, the first inclined direction DD1, and the second inclined direction DD2 (see FIG. 5).

The input operation identifier 232 is configured to identify one or more input operations by at least one foot D4 of the driver D based on the recognized state of the at least one foot D4 of the driver D.

Specifically, the input operation identifier 232 includes a lookup table that maps various states of each of the feet D4 of the driver D to corresponding respective vehicle control operations, and is configured to retrieve, from the lookup table, at least one vehicle control operation corresponding to the recognized state of the at least one foot D4 of the driver D. Then, the control operation determiner 234 determines to control the host vehicle V based on the retrieved at least one vehicle control operation.

Input operations using at least one foot D4 of the driver D can be used, for example, to select functions related to driving assistance of the host vehicle V. Specifically, referring to FIG. 5 as an example, reciprocating motions of the left foot D42 of the driver D in the first inclined direction DD1 may be associated with activation of ACC, and reciprocating motions of the left foot D42 of the driver D in the second inclined direction DD2 may be associated with deactivation of ACC.

Additionally, while ACC is activated, reciprocating motions of the left foot D42 of the driver D in the foot length direction DL may be associated with an instruction to reduce the inter-vehicle distance, and reciprocating motions of the left foot D42 of the driver D in the foot width direction DW may be associated with an instruction to increase the inter-vehicle distance.

Furthermore, a driver's motion of stepping down the left foot D42 with the left shin D53 externally rotated so that the toe of the left foot D42 is rotated counterclockwise may be associated with activation of EPB (Electronic Parking Braking), and a driver's motion opposite to the above-described motion may be associated with deactivation of EPB.

Input operations using at least one foot D4 of the driver D can be used, for example, to operate the air-conditioning system 18. Specifically, referring to FIG. 5 as an example, a driver's motion or a gesture of moving the left foot D42 in a clockwise circular motion may be associated with activation (turn-on) of the air-conditioning system 18, whereas the reverse motion or gesture may be associated with deactivation (turn-off) of the air-conditioning system 18.

In a so-called internal combustion engine vehicle, it is generally necessary to start the engine to activate the air-conditioning system 18. Similarly, in a so-called hybrid vehicle or plug-in hybrid vehicle, starting the engine is typically required to activate the air-conditioning system 18 when the remaining capacity of the battery of the host vehicle V is lower than a predetermined threshold. In this regard, the vehicular system 1 of the present embodiment enables the driver D to initiate starting of the engine along with activation of the air-conditioning system 18, while the brake pedal V72 is kept depressed with the right foot D41.

Input operations using at least one foot D4 of the driver D can be used, for example, to instruct the interior lighting system 19 and/or the output unit 21 to execute various operations. Specifically, rhythmic repeated motions of the left foot D42 of the driver D in the dorsiflexion direction and the plantarflexion direction instruct each of the LEDs (Light-Emitting Diodes) and/or organic EL (Electro-Luminescence) light emitting devices included in the interior lighting system 19 and/or the output unit 21 to adjust luminance and/or color transitions. This elevates the interior ambiance in the host vehicle V.

Input Operations Using the Left Foot D42 of the Driver D Can Be Used, for example, for volume adjustment. During autonomous driving mode, motions and/or gestures of the right foot D41 of the driver D can be used, for example, to start, select, switch, or terminate secondary task content.

Conditions in the footwell space V6 are important for performing the input operations using the various foot states set forth above. That is, for example, the presence of obstacles in the footwell space V6, anomalies of the floor mat V10, and/or the presence of deposits on each pedal V7 may interfere with such input operations.

From this viewpoint, the footwell condition determiner 233 is configured to determine whether at least one motion hindrance condition that hinders motion of the feet D4 has occurred in the footwell space V6. When the footwell condition determiner 233 determines that the at least one motion hindrance condition has occurred in the footwell space V6, the control operation determiner 234 issues a warning to the driver D via the output unit 21 (e.g., the instrument panel 211, the HUD 213, and/or the speaker 215).

While the present embodiment of the present disclosure has been described above, the present disclosure is not limited to the present embodiment. Specifically, the present disclosure includes various modifications and/or alternatives of the present embodiment within the scope of the present disclosure.

The following describes typical modifications of the present embodiment. In the typical modifications, to the same parts or equivalent parts of the present embodiment, like reference characters are assigned, so that, as the descriptions of each of the same or equivalent parts of the typical modifications, the descriptions of the corresponding one of the same or equivalent parts of the present embodiment can be employed unless technical contradiction or otherwise specified.

The present disclosure is not limited at all to the specific device configuration shown in the above embodiment. For example, the vehicle V in which the vehicular system 1 is installed is not limited to a passenger vehicle. Specifically, such a vehicle V may be a large vehicle such as a freight truck. There is no particular limitation on the number of wheels, and it may be a three-wheeled vehicle, or a six-wheeled or eight-wheeled vehicle such as a freight truck. The type of the vehicle V may be a conventional vehicle equipped only with an internal combustion engine, an electric vehicle or a fuel cell vehicle not equipped with an internal combustion engine, or a so-called hybrid vehicle. The shape and structure of the vehicle body V1 are also not limited to a box shape, i.e., a substantially rectangular shape in a plan view. There are also no particular limitations on the use of the vehicle V, the positions of the driver's seat V3 and the steering wheel V5 in the vehicle width direction, the number of occupants, and the like. That is, for example, the host vehicle V may have a configuration as a so-called “left-hand drive vehicle” adapted to a road traffic legal system of right-hand traffic in the United States or the like. Alternatively, for example, the host vehicle V may have a configuration in which seats for occupants are provided on both the left and right sides of the driver's seat V3.

As a communication standard for configuring the in-vehicle system 1, one other than CAN®, such as FlexRay®, may also be adopted. Further, the communication standard for configuring the vehicular system 1 is not limited to one type. For example, the vehicular system 1 may have a sub-network line compliant with a communication standard such as LIN. LIN is an abbreviation for Local Interconnect Network.

The vehicle state sensor unit 11, the external state sensor unit 12, and the surround monitoring sensor unit 13 are also not limited to the above embodiment and examples. For example, the surround monitoring sensor unit 13 may include one or more sonars, i.e., ultrasonic sensors. Alternatively, the surround monitoring sensor unit 13 may include two or more types of sensors among a millimeter-wave radar sensor, a submillimeter-wave radar sensor, a laser radar sensor, and an ultrasonic sensor. There are also no particular limitations on the number of various types of sensors installed to the host vehicle V.

The locator 14 is not limited to the above embodiment and examples. For example, the locator 14 may be not comprised of a three-axis accelerometer and a three-axis gyro sensor in the housing thereof. Specifically, the inertial sensor 142 of the locator 14 may be configured to receive output signals from a three-axis accelerometer and a three-axis gyro sensor, such as an angular velocity sensor, provided outside the housing of the locator 14, which are included in the vehicle state sensor unit 11.

In the above embodiment, the driving control device 17 is configured to be capable of executing vehicle control operations corresponding to the SAE levels 0 to 4. However, the present disclosure is not limited to such a configuration.

Specifically, the driving control device 17 of the present disclosure may be configured to execute vehicle control operations corresponding to the SAE levels 1 to 5. Additionally, the driving automation levels or their categories may be not limited to those defined in “SAE J3016”.

Specifically, in “SAE J3016”, it is defined that the higher the driving automation level is, the larger the numerical value corresponding to the driving automation level becomes. However, the present disclosure is not limited to such a definition. That is, the present disclosure can be similarly applied to a standard in which the highest driving automation level is “Level 1” and the numerical value corresponding to the driving automation level increases as the driving automation level decreases.

The output unit 21 is not limited to the above configuration including the instrument panel 211, the console display device 212, and the HUD device 213. Specifically, the instrument panel 211 and the console display device 212 may be integrated with one another. The HUD device 213 may be omitted.

The input unit 22 is also not limited to the above configuration. Specifically, the input unit 22 may for example include a touch panel mounted on the display surface of the instrument panel 211 or the console display 212 instead of or together with the meter switches 221 and the console switches 222.

The above embodiment uses a footwell camera as the footwell condition sensor 225. Such a footwell camera may be a visible light camera, an infrared camera, or a combination of both of the cameras. The present disclosure is, however, not limited to the above configuration. Specifically, instead of or together with the footwell camera, an ultrasonic sensor or one or more other sensors may be used as the footwell condition sensor 225.

The present disclosure is not limited to the specific operation examples described in the above embodiment and examples. For example, as illustrated in FIG. 5, the foot length direction DL may be the longitudinal direction, and the foot width direction DW may be the lateral direction.

Specifically, the motions or gestures of at least one foot D4 of the driver D are typically based on rotational movements centered on one or more joints, such as the knee D51 and the ankle D6, of the corresponding at least one leg D5. Therefore, even if the driver D intends to move at least one foot D4 in a “back-and-forth direction”, the at least one foot D4 actually moves along an arcuate trajectory centered on the corresponding at least one knee D51. For this reason, strictly speaking, a motion of at least one foot D4 in the foot-length direction DL is a motion along an arcuate trajectory between a diagonally forward-upward position and a diagonally backward-downward position relative to the corresponding at least one knee D51. However, it is also possible for the driver D to intentionally move the at least one foot D4 in a direction parallel to the longitudinal direction. Furthermore, input operation methods based on the states of the at least one driver's leg D5 other than those described above may be employed. Specifically, for example, motions of at least one knee D51 of at least one leg D5 may also be used as the input operations.

Similar expressions, such as “obtaining”, “calculation”, “estimation”, “detection”, and “determination”, can be mutually substituted for one another unless the substitution produces technological inconsistency.

One or more components in the present embodiment are not necessarily essential components except for (i) one or more components that are described as one or more essential components or (ii) one or more components that are essential in principle.

Specific values disclosed in the present embodiment, each of which represents the number of components, a physical quantity, and/or a range of a physical parameter, are not limited thereto except that (i) the specific values are obviously essential or (ii) the specific values are essential in principle.

The specific structure and direction of each component described in the present embodiment are not limited thereto except for cases in which (1) the specific structure and direction are described to be essential or (2) the specific structure and direction are required in principle. Additionally, the specific structural or functional relationship between components described in the present embodiment is not limited thereto except for cases in which (1) the specific structural or functional relationship is described to be essential or (2) the specific structural or functional relationship is required in principle.

Modifications of the present disclosure are not limited to those described set forth above. For example, specific examples described set forth above can be combined with each other unless the combination produces technological inconsistency, and similarly the modifications set forth above can be combined with each other unless the combination produces technological inconsistency. At least part of the present embodiment can be combined with at least part of the modifications set forth above unless the combination produces technological inconsistency.

As apparent by the descriptions of the above present embodiment and its modifications, the present disclosure includes at least the following technological aspects

### Technological Aspect 1

A vehicular interface apparatus (20) to be installed in a vehicle (V) for accepting a driver's input according to the technological aspect 1 includes a controller (23). The controller is configured to detect, using a contactless sensor (225) mounted to the vehicle, leg state information including at least a motion of at least one foot (D4) of a driver, and analyze the leg state information to thereby identify at least one driver's input operation indicated by the leg state information.

### Technological Aspect 2

In the vehicular interface apparatus according to the technological aspect 2, which depends from the technological aspect 1, the controller is configured to detect, using the contactless sensor, at least one driver's gesture as the leg state information in a non-contact manner, the at least one driver's gesture including a motion of the at least one foot of the driver in at least one of (i) a first direction (DL) along a longitudinal direction of the vehicle, (ii) a second direction (DW) along a left-right direction of the vehicle, and (iii) a third direction (DS) intersecting both the first and second directions. The controller is configured to analyze the at least one driver's gesture to thereby identify the at least one driver's input operation indicated by the at least one driver's gesture.

### Technological Aspect 3

In the vehicular interface apparatus according to the technological aspect 3, which depends from the technological aspect 1 or 2, the at least one foot of the driver is a left foot (D42) thereof, and the controller is configured to detect, using the contactless sensor mounted to the vehicle, the leg state information including the motion of the left leg of the driver in a non-contact manner.

### Technological Aspect 4

In the vehicular interface apparatus according to the technological aspect 4, which depends from any one of the technological aspects 1 to 3, the at least one driver's input operation indicated by the leg state information includes selection of a plurality of functions related to driving assistance of the vehicle.

### Technological Aspect 5

In the vehicular interface apparatus according to the technological aspect 5, which depends from any one of the technological aspects 1 to 4, the at least one driver's input operation indicated by the leg state information includes an operation of parking braking of the vehicle.

### Technological Aspect 6

In the vehicular interface apparatus according to the technological aspect 6, which depends from any one of the technological aspects 1 to 5, the at least one driver's input operation indicated by the leg state information includes an operation of an air-conditioning system installed in the vehicle.

### Technological Aspect 7

In the vehicular interface apparatus according to the technological aspect 7, which depends from any one of the technological aspects 1 to 6, the at least one driver's input operation indicated by the leg state information includes an instruction to operate a vehicular device (19, 21) designed to provide visual and/or auditory feedback to the driver.

### Technological Aspect 8

In the vehicular interface apparatus according to the technological aspect 8, which depends from any one of the technological aspects 1 to 7, the controller is configured to identify, using the contactless sensor, a surrounding condition around feet of the driver, determine, based on the identified surrounding condition, whether a motion hindrance condition that hinders motion of the feet has occurred, and issue a warning to the driver when it is determined that the motion hindrance condition has occurred.

### Technological Aspect 9

In the vehicular interface apparatus according to the technological aspect 9, which depends from the technological aspect 8, the motion hindrance condition includes at least one of (i) a presence of one or more obstacles in a footwell space (V6) of the vehicle, (ii) one or more anomalies of a floor mat (V10) laid on a floor (V9) of the vehicle, and (iii) a presence of one or more deposits on at least one pedal (V7) of the vehicle.

1. A vehicular interface apparatus to be installed in a vehicle for accepting a driver's input, the vehicular interface apparatus comprising:
a controller configured to:
detect, using a contactless sensor mounted to the vehicle, leg state information including at least a motion of at least one foot of a driver; and
analyze the leg state information to thereby identify at least one driver's input operation indicated by the leg state information.

2. The vehicular interface apparatus according to claim 1, wherein:
the controller is configured to:
detect, using the contactless sensor, at least one driver's gesture as the leg state information in a non-contact manner, the at least one driver's gesture including a motion of the at least one foot of the driver in at least one of (i) a first direction along a longitudinal direction of the vehicle, (ii) a second direction along a left-right direction of the vehicle, and (iii) a third direction intersecting both the first and second directions; and
analyze the at least one driver's gesture to thereby identify the at least one driver's input operation indicated by the at least one driver's gesture.

3. The vehicular interface apparatus according to claim 1, wherein:
the at least one foot of the driver is a left foot thereof; and
the controller is configured to detect, using the contactless sensor mounted to the vehicle, the leg state information including the motion of the left leg of the driver in a non-contact manner.

4. The vehicular interface apparatus according to claim 1, wherein:
the at least one driver's input operation indicated by the leg state information includes selection of a plurality of functions related to driving assistance of the vehicle.

5. The vehicular interface apparatus according to claim 1, wherein:
the at least one driver's input operation indicated by the leg state information includes an operation of parking braking of the vehicle.

6. The vehicular interface apparatus according to claim 1, wherein:
the at least one driver's input operation indicated by the leg state information includes an operation of an air-conditioning system installed in the vehicle.

7. The vehicular interface apparatus according to claim 1, wherein:
the at least one driver's input operation indicated by the leg state information includes an instruction to operate a vehicular device designed to provide visual and/or auditory feedback to the driver.

8. The vehicular interface apparatus according to claim 1, wherein:
the controller is configured to:
identify, using the contactless sensor, a surrounding condition around feet of the driver;
determine, based on the identified surrounding condition, whether a motion hindrance condition that hinders motion of the feet has occurred; and
issue a warning to the driver when it is determined that the motion hindrance condition has occurred.

9. The vehicular interface apparatus according to claim 8, wherein:
the motion hindrance condition includes at least one of (i) a presence of one or more obstacles in a footwell space of the vehicle, (ii) one or more anomalies of a floor mat laid on a floor of the vehicle, and (iii) a presence of one or more deposits on at least one pedal of the vehicle.
